(19) United States
(12) Patent Application Publication
(10) Pub. No.: US 2025/0285312 A1
(43) Pub. Date: Sep. 11, 2025

(54) Method For Predicting Volume Of Object Based On Whether Object In Container Changes

(71) Applicant: NUVILABS Co., Ltd., Seo-gu (KR)

(72) Inventor: Eunseong CHA, Seoul (KR)

(73) Assignee: NUVILABS Co., Ltd., Seo-gu (KR)

(21) Appl. No.: 19/067,041

(22) Filed: Feb. 28, 2025

(30) Foreign Application Priority Data
Mar. 8, 2024 (KR) 10-2024-0033113

(51) Int. Cl. G06T 7/62

(52) U.S. Cl. CPC G06T 7/62; G06T 2207/10028

(57) ABSTRACT

Disclosed is a method for predicting a volume of an object, the method performed by one or more processors of a computing device according to an exemplary embodiment of the present disclosure.

The method may include: obtaining a plurality of multi-dimensional data including a container capable of containing an object based on time-series information; obtaining first reference time multi-dimensional data based on whether the plurality of multi-dimensional data are changed; identifying whether a plurality of additional multi-dimensional data after the plurality of multi-dimensional data are changed; obtaining second reference time multi-dimensional data among the plurality of additional multi-dimensional data based on identified changed; and predicting the volume of the object based on the first reference time multi-dimensional data and the second reference time multi-dimensional data.

### CROSS-REFERENCE TO RELATED APPLICATIONS

This application claims priority to and the benefit of Korean Patent Application No. 10-2024-0033113 filed in the Korean Intellectual Property Office on Mar. 8, 2024, the entire contents of which are incorporated herein by reference.

### TECHNICAL FIELD

The present disclosure relates to a method for predicting a volume of an object, and more particularly, to a method for estimating whether an object in a container changes by using multi-dimensional data of the container containing the object, and predicting a volume of the object based on the estimated whether the object changes.

### BACKGROUND ART

In related art, in order to calculate the amount of food waste, various methods such as video analysis and photographic measurement, measurement using a metering device, and a measurement method using geometric modeling were used. However, in the case of the video analysis and the photographic measurement, there is a problem that requires appropriate angle and lighting for accurate volume measurement, and the accuracy can be reduced due to texture or color fluctuations. In addition, in the case of the method using the metering device, it was difficult to estimate a volume of foods with a variable density only with a weight. Therefore, in recent years, a scheme has been used, which takes photos of food contained in the container with a deep camera to predict the volume of a load amount of the food waste. However, in the process of predicting the volume of the load amount of the food waste in real time, it was necessary to accurately identify a reference point before and after the volume changed, but it was difficult to accurately identify the reference time before and after the volume of the food waste in which the volume changed in real time changed. Therefore, there is a need for a method in which the reference time before and after the volume of the object changed is identified by utilizing the multi-dimensional data of the container containing the object to estimate whether the object contained in the container changes, and predict an accurate volume of the object based on the estimated whether the object changes.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to provide a method for predicting a volume of an object, and more particularly, a method for estimating whether an object in a container changes by using multi-dimensional data of the container containing the object, and predicting a volume of the object based on the estimated whether the object changes.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: obtaining a plurality of multi-dimensional data including a container capable of containing an object based on time-series information; obtaining first reference time multi-dimensional data based on whether the plurality of multi-dimensional data are changed; identifying whether a plurality of additional multi-dimensional data after the plurality of multi-dimensional data are changed; obtaining second reference time multi-dimensional data among the plurality of additional multi-dimensional data based on identified change; and predicting the volume of the object based on the first reference time multi-dimensional data and the second reference time multi-dimensional data.

Alternatively, a plurality of multi-dimensional data including the container capable of the object may be obtained based on a process of obtaining a plurality of depth data including the container by using a depth camera.

Alternatively, the multi-dimensional data may include RGBD data.

Alternatively, the obtaining of the plurality of multi-dimensional data including the container based on the time-series information further may include identifying an area including the container for at least one of the plurality of obtained multi-dimensional data, and filtering the multi-dimensional data based on the identified area.

Alternatively, the filtering of the multi-dimensional data based on the identified area may include filtering the multi-dimensional data based on depth data of the identified area.

Alternatively, the identifying of the area including the container for at least one of the plurality of obtained multi-dimensional data may include extracting an external contour of an object for at least one of the plurality of obtained multi-dimensional data, extracting an internal contour of the container for at least one of the plurality of obtained multi-dimensional data, and identifying an area including the container for at least one of the plurality of obtained multi-dimensional data based on the external contour of the object and the extracted internal contour of the container.

Alternatively, the extracting of the external contour of the object for at least one of the plurality of obtained multi-dimensional data may include obtaining an approximation area of the object based on the external contour of the object, and the identifying of the area including the container for at least one of the plurality of obtained multi-dimensional data based on the external contour of the object and the extracted internal contour of the container may include extracting an approximation area of the container based on a distance between the approximation area of the object and the internal contour of the container, and identifying the area including the container for at least one of the plurality of obtained multi-dimensional data based on the approximation area of the container.

Alternatively, the obtaining of the first reference time multi-dimensional data based on whether there are the changes between the plurality of multi-dimensional data may include identifying a first area included in first multi-dimensional data among the plurality of multi-dimensional data, identifying whether a data value of the first area is changed in second multi-dimensional data at a time after the first multi-dimensional data among the plurality of multi-dimensional data, and obtaining first reference time multi-dimensional data based on whether the data value of the first area is changed, which is identified.

Alternatively, the obtaining of the first reference time multi-dimensional data based on whether the data value of the first area is changed, which is identified, which is identified may include obtaining the second multi-dimensional data as the first reference time multi-dimensional data when the identified change of the data value of the first area is within a predetermined threshold.

Alternatively, the identifying of whether the plurality of additional multi-dimensional data after the plurality of multi-dimensional data are changed may include identifying a change in data value between first additional multi-dimensional data among the plurality of additional multi-dimensional data, and the first reference time multi-dimensional data, and when the identified change in data value between the first additional multi-dimensional data and the first reference time multi-dimensional data is equal to or larger than a predetermined threshold, comparing the first additional multi-dimensional data and the first reference time multi-dimensional data to determine that the change of the data value occurs.

Alternatively, the obtaining of the second reference time multi-dimensional data among the plurality of additional multi-dimensional data based on identified change may include when it is determined that the change of the data value occurs by comparing the first additional multi-dimensional data and the first reference time multi-dimensional data, obtaining the first additional multi-dimensional data as temporary reference time multi-dimensional data, identifying whether there is a change in data value between second additional multi-dimensional data and the temporary reference time multi-dimensional data, and obtaining the second reference time multi-dimensional data based on whether there is the change in data value between the second additional multi-dimensional data and the temporary reference time multi-dimensional data.

Alternatively, the obtaining of the second reference time multi-dimensional data based on whether there is the change in data value between the second additional multi-dimensional data and the temporary reference time multi-dimensional data may include when the change in data value between the second additional multi-dimensional data and the temporary reference time multi-dimensional data is within a predetermined threshold, obtaining the second additional multi-dimensional data as the second reference time multi-dimensional data.

Another exemplary embodiment of the present disclosure provides a computer program stored in a computer readable medium. The computer program may allow one or more processors to perform operations for predicting a volume of an object when the computer program is executed by the one or more processors, and the operations may include: an operation of obtaining a plurality of multi-dimensional data including a container capable of containing an object based on time-series information; an operation of identifying whether a plurality of additional multi-dimensional data after the plurality of multi-dimensional data are changed; an operation of obtaining second reference time multi-dimensional data among the plurality of additional multi-dimensional data based on identified change; and an operation of predicting the volume of the object based on the first reference time multi-dimensional data and the second reference time multi-dimensional data.

Alternatively, the operation of obtaining the plurality of multi-dimensional data including the container capable of containing the object based on the time-series information may further include an operation of identifying an area including the container for at least one of the plurality of obtained multi-dimensional data, and an operation of filtering the multi-dimensional data based on the identified area.

Alternatively, the operation of filtering the multi-dimensional data based on the identified area may include an operation of filtering the multi-dimensional data based on depth data of the identified area.

Alternatively, the operation of identifying the area including the container for at least one of the plurality of obtained multi-dimensional data may include an operation of extracting an external contour of an object for at least one of the plurality of obtained multi-dimensional data, an operation of extracting an internal contour of the container for at least one of the plurality of obtained multi-dimensional data, and an operation of identifying an area including the container for at least one of the plurality of obtained multi-dimensional data based on the external contour of the object and the extracted internal contour of the container.

Alternatively, the operation of obtaining the first reference time multi-dimensional data based on whether there are the changes between the plurality of multi-dimensional data may include an operation of identifying a first area included in first multi-dimensional data among the plurality of multi-dimensional data, an operation of identifying whether a data value of the first area is changed in second multi-dimensional data at a time after the first multi-dimensional data among the plurality of multi-dimensional data, and an operation of obtaining first reference time multi-dimensional data based on whether the data value of the first area is changed, which is identified.

Alternatively, the operation of obtaining the first reference time multi-dimensional data based on whether the data value of the first area is changed, which is identified, which is identified may include an operation of obtaining the second multi-dimensional data as the first reference time multi-dimensional data when the identified change of the data value of the first area is within a predetermined threshold.

Alternatively, the operation of identifying whether the plurality of additional multi-dimensional data after the plurality of multi-dimensional data are changed may include an operation of identifying a change in data value between first additional multi-dimensional data among the plurality of additional multi-dimensional data, and the first reference time multi-dimensional data, and when the identified change in data value between the first additional multi-dimensional data and the first reference time multi-dimensional data is equal to or larger than a predetermined threshold, an operation of comparing the first additional multi-dimensional data and the first reference time multi-dimensional data to determine that the change of the data value occurs.

Alternatively, the operation of obtaining the second reference time multi- dimensional data among the plurality of additional multi-dimensional data based on identified change may include when it is determined that the change of the data value occurs by comparing the first additional multi-dimensional data and the first reference time multi-dimensional data, an operation of obtaining the first additional multi-dimensional data as temporary reference time multi-dimensional data, an operation of identifying whether there is a change in data value between second additional multi-dimensional data and the temporary reference time multi-dimensional data, and an operation of obtaining the second reference time multi-dimensional data based on whether there is the change in data value between the second additional multi-dimensional data and the temporary reference time multi-dimensional data.

Yet another exemplary embodiment of the present disclosure provides a computing device. The device may include: at least one processor; and a memory, and the at least one processor may be configured to obtain a plurality of multi-dimensional data including a container capable of containing an object based on time-series information; obtain first reference time multi-dimensional data based on whether the plurality of multi-dimensional data are changed; identify whether a plurality of additional multi-dimensional data after the plurality of multi-dimensional data are changed; obtain second reference time multi-dimensional data among the plurality of additional multi-dimensional data based on identified change; and predict the volume of the object based on the first reference time multi-dimensional data and the second reference time multi-dimensional data.

Still yet another exemplary embodiment of the present disclosure provides a data structure included in a computer-readable storage medium. The data structure may correspond to a parameter of a neural network, and the neural network may perform the following steps at least partially based on the parameter, and the steps may include: at least method may include: obtaining a plurality of multi-dimensional data including a container capable of containing an object based on time-series information; obtaining first reference time multi-dimensional data based on whether the plurality of multi-dimensional data are changed; identifying whether a plurality of additional multi-dimensional data after the plurality of multi-dimensional data are changed; obtaining second reference time multi-dimensional data among the plurality of additional multi-dimensional data based on identified change; and predicting the volume of the object based on the first reference time multi-dimensional data and the second reference time multi-dimensional data.

According to an exemplary embodiment of the present disclosure, a method for predicting a volume of an object can be provided, and more particularly, it is possible to estimate whether an object in a container changes by using multi-dimensional data of the container containing the object, and predict a volume of the object based on whether the object changes which is estimated to more accurately predict the volume of the object.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device for predicting a volume of an object according to an exemplary embodiment of the present disclosure.

FIG. 2 is a schematic diagram illustrating a network function according to an exemplary embodiment of the present disclosure.

FIG. 3 is a flowchart illustrating a method for predicting a volume of an object according to an exemplary embodiment of the present disclosure.

FIG. 4 is a schematic view for describing a process of obtaining a plurality of multi-dimensional data including a container capable of containing an object based on time-series information according to an exemplary embodiment of the present disclosure.

FIGS. 5A and 5B are schematic views for describing a process of identifying an area including the container for at least one of the plurality of obtained multi-dimensional data, and filtering the multi-dimensional data based on the identified area according to an exemplary embodiment of the present disclosure.

FIGS. 6A and 6B are schematic views for describing a process of obtaining first reference time multi-dimensional data based on whether the plurality of multi-dimensional data are changed according to an exemplary embodiment of the present disclosure.

FIG. 7 is a schematic view for describing a process of identifying whether a plurality of additional multi-dimensional data change after the plurality of multi-dimensional data, and obtaining second reference time multi-dimensional data among the plurality of additional multi-dimensional data based on whether the plurality of additional multi-dimensional data change, which is identified according to an exemplary embodiment of the present disclosure.

FIG. 8 is a simple and normal schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein. In the present disclosure, a network function and an artificial neural network and a neural network may be interchangeably used.

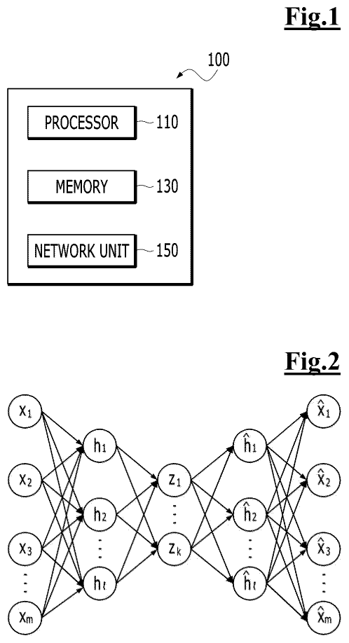

FIG. 1 is a block diagram of a computing device for predicting a volume of an object according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back- propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

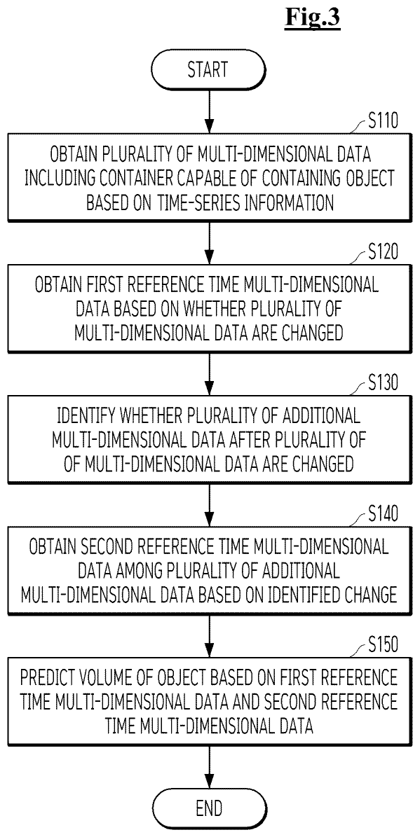

FIG. 3 is a flowchart illustrating a method for predicting a volume of an object according to an exemplary embodiment of the present disclosure.

A computing device 100 according to an exemplary embodiment of the present disclosure may directly obtain “information for predicting a volume of an object” or receive the “information for predicting the volume of the object” from an external system. The external system may be a server or database that stores and manages the information for predicting the volume of the object. The computing device 100 may use the information obtained directly or received from the external system as “input data for predicting the volume of the object”.

According to an exemplary embodiment of the present disclosure, the computing device 100 may obtain a plurality of multi-dimensional data including a container capable of containing an object based on time-series information (S110). In this case, the time-series information may mean information that may distinguish the plurality of multi-dimensional data using a time difference, and for example, the plurality of multi-dimensional data may be divided into T1-time multi-dimensional data and T2-time multi-dimensional data. For example, the computing device 100 may obtain a plurality of depth data containing the container capable of containing an object using a depth camera, and the multi-dimensional data may include RGBD data. In this case, the depth camera may mean a camera that measures distance information to a specific point of an environment or an object, and the depth camera may include, for example, a camera which measures a depth value of each pixel in a 2D image to secure 3D information of a space. On the other hand, the plurality of multi-dimensional data may be obtained through technologies such as laser scanning, structural light scanning, a time-of-flight camera, a stereo vision system, photogrammetry, etc., in addition to a scheme of using the depth camera, and are not limited to an example such as the depth camera, etc.

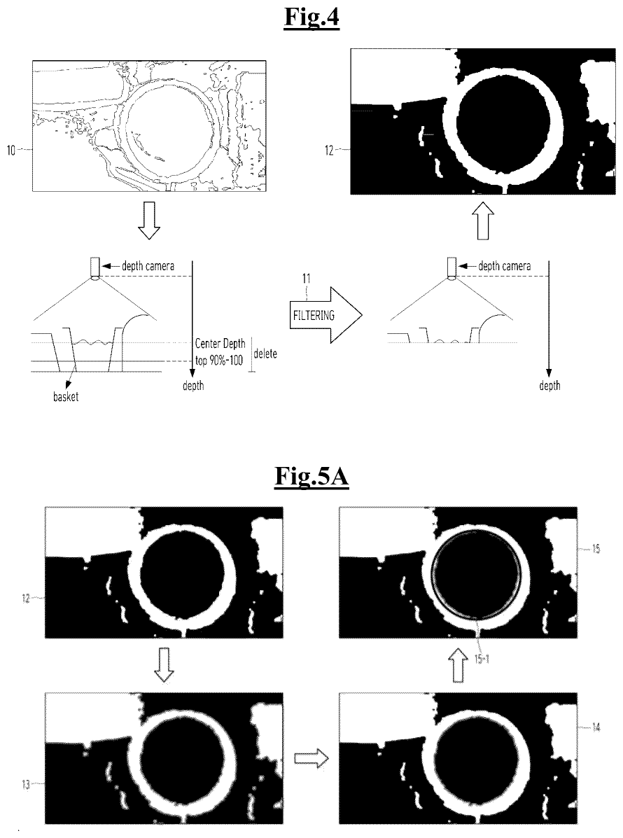

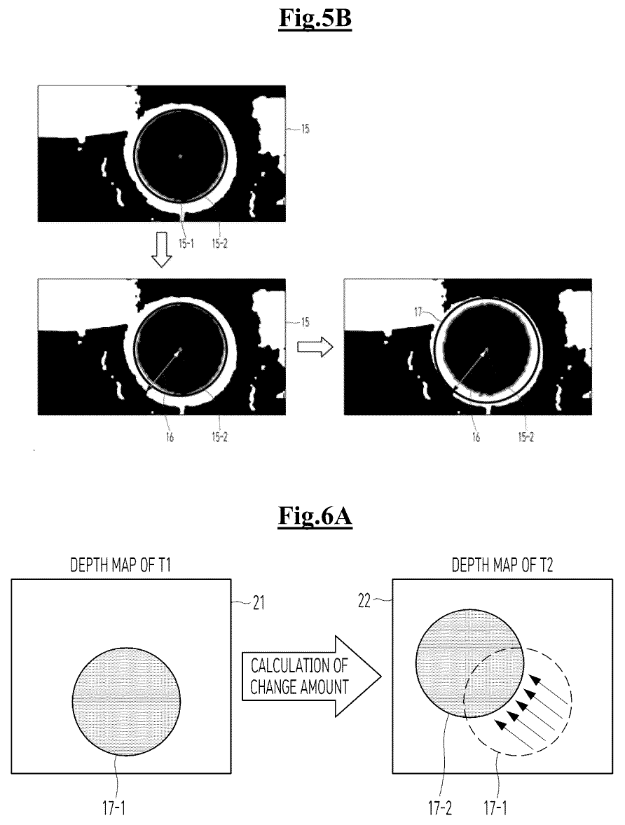

Additionally, according to an exemplary embodiment of the present disclosure, the computing device 100 identifies an area including the container for at least one of the plurality of obtained multi-dimensional data, and filters the multi-dimensional data based on the identified area to obtain filtered multi-dimensional data. In this case, the computing device 100 may extract an external contour of the object for at least one of the plurality of obtained multi-dimensional data, and extract an internal contour of the container for at least one of the plurality of obtained multi-dimensional data, and identify the area including the container for at least one of the plurality of obtained multi-dimensional data based on the external contour of the object and the internal contour of the container. Specifically, the computing device 100 may obtain an approximation area of the object based on the external contour of the object, extract an approximation area of the container based on a distance between the approximation area of the object and the internal contour of the container, and identify the area for at least one of the plurality of obtained multi-dimensional data based on the approximation area of the container. In this regard, a specific description of the process in which the computing device 100 identifies the area including the container for at least one of the plurality of multi-dimensional data is described below through FIGS. 5A and 5B.

As an additional example, the computing device 100 may filter the multi-dimensional data based on depth data of the identified area. Specifically, the computing device 100 may perform filtering for the multi-dimensional data by filtering an area having a depth value smaller than the depth data of the identified area based on the depth data of the identified area, but even in addition to the above example, various examples may be used. Meanwhile, a process in which the computing device 100 filters the multi-dimensional data based on the depth data of the identified area is described below through FIG. 4.

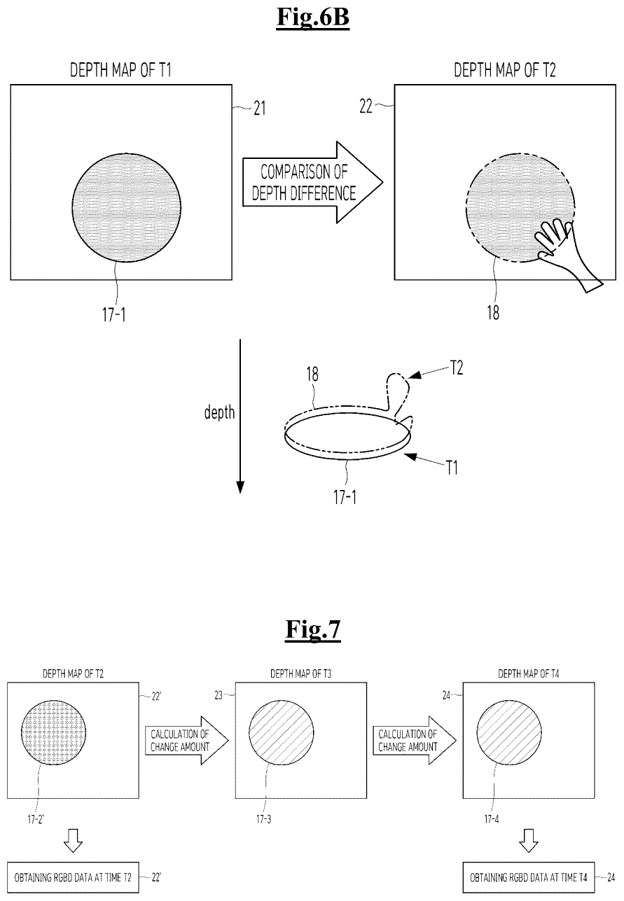

According to an exemplary embodiment of the present disclosure, the computing device 100 may obtain first reference time multi-dimensional data based on whether the plurality of multi-dimensional data are changed obtained through step S110 (S120). For example, the computing device 100 may identify a first area including first multi-dimensional data among the plurality of multi-dimensional data, identify whether a data value of the first area is changed in second multi-dimensional data at a time after the first multi-dimensional data among the plurality of multi-dimensional data, and obtain the first reference time multi-dimensional data based on the identified whether the data value of the first area is changed. At this time, the first area may mean a specific area included in the first or second multi-dimensional data, and for example, when the first or second multi-dimensional data is an RGBD image, the first area may mean an area of the container in an entire image, but is not limited thereto. Further, when the identified change of the data value of the first area is within a predetermined threshold, the computing device 100 may obtain the second multi-dimensional data as the first reference time multi-dimensional data. In this regard, in order for the computing device 100 to predict the volume of the object which changes in real time, a process of accurately setting a first reference time at which the change of the volume is started and a second reference time at which the change of the volume is terminated is required. In this case, the first reference time may mean a time when the change of the object which becomes a target of the volume prediction is not started, and there should be no change in the multi-dimensional data at the first reference time. For example, when food waste is loaded in the container sequentially over time, the depth data of the container may continue to change while the food waste is being loaded, and a time when the depth data of the container is not changed may be a time when the loading of the food waste is terminated or a time when the loading of the food waste is not started. Accordingly, the computing device 100 may identify whether the data value of the first area is changed in the second multi-dimensional data at the time after the first multi-dimensional data among the plurality of multi-dimensional data, and when the identified change of the data value of the first area is within a predetermined threshold, the computing device 100 obtains the second multi-dimensional data as the first reference time multi-dimensional data to specify the first reference time at which the change of the volume of the container capable of the object is started and obtain the second multi-dimensional data as the first reference time multi-dimensional data. Meanwhile, a specific description for the process of obtaining the first reference time multi-dimensional data 100 is described below through FIGS. 6A and 6B below.

According to an exemplary embodiment of the present disclosure, the computing device 100 may identify whether a plurality of additional multi-dimensional data after the plurality of multi-dimensional data obtained through step S110 are changed (S130). For example, the computing device 100 may identify a change in data value between first additional multi-dimensional data among the plurality of additional multi-dimensional data, and the first reference time multi-dimensional data. In this case, the plurality of additional multi-dimensional data may mean data distinguished from the plurality of obtained multi-dimensional data, and may include multi-dimensional data at the time after the plurality of multi-dimensional data. For example, when the plurality of multi-dimensional data are multi-dimensional data from the time T1 to the time T2, the plurality of additional multi-dimensional data may include multi-dimensional data after a time T3. Further, when the identified change in data value between the first additional multi-dimensional data and the first reference time multi-dimensional data is equal to or larger than the predetermined threshold, the computing device 100 compares the first additional multi-dimensional data and the first reference time multi-dimensional data to determine that the change of the data value occurs. At this time, when the computing device 100 determines that the change of the data value occurs by comparing the first additional multi-dimensional data and the first reference time multi-dimensional data, the computing device 100 may determine that the volume changes in real time. Thereafter, the computing device 100 may use the first additional multi-dimensional data in the process of obtaining second reference time multi-dimensional data, and a specific description related thereto will be described below through FIG. 7 below.

According to an exemplary embodiment of the present disclosure, the computing device 100 may obtain the second reference time multi-dimensional data among the plurality of additional multi-dimensional data based on whether there is the change identified through step S130 (S140). Specifically, when the computing device 100 determines that the change of the data value occurs by comparing the first additional multi-dimensional data and the first reference time multi-dimensional data, the computing device 100 may obtain the first additional multi-dimensional data as temporary reference time multi-dimensional data. In this case, the temporary reference time multi-dimensional data may mean data used in a process of obtaining the second reference time multi-dimensional data. For example, the computing device 100 may obtain t2-time multi-dimensional data as the first reference time multi-dimensional data, and when determining that there is a change in data value by comparing t3-time multi-dimensional data with the t2-time multi-dimensional data, the computing device 100 may obtain the t3-time multi-dimensional data as the temporary reference time multi-dimensional data.

Thereafter, the computing device 100 may identify whether there is a change in data value between the second additional multi-dimensional data and the temporary reference time multi-dimensional data. For example, the computing device 100 may identify whether there is a change in data value between second additional multi-dimensional data at a time t4 after the temporary reference time multi-dimensional data and the temporary reference time multi-dimensional data at the time t3. In this case, when a change in data value between the second additional multi-dimensional data at the time t4 and the temporary reference time multi-dimensional data at the time t3 is larger than a predetermined threshold, the computing device 100 may set the second additional multi-dimensional data at the time t4 as the temporary reference time multi-dimensional data again. Through this, when the volume of the object which becomes the prediction target is changed in real time, the computing device 100 may obtain additional multi-dimensional data obtained at a recent time as the temporary reference time multi-dimensional data, and may use the obtained temporary reference time multi-dimensional data in a process of obtaining second reference time multi-dimensional data to be described below to more accurately identify the time when the change of the volume of the object is terminated. In this regard, the computing device 100 may obtain the second reference time multi-dimensional data based on whether there is a change in data value between the second additional multi-dimensional data and the temporary reference time multi-dimensional data. Specifically, when the change in data value between the second additional multi-dimensional data and the temporary reference time multi-dimensional data is within the predetermined threshold, the computing device 100 may obtain the second additional multi-dimensional data as the second reference time multi-dimensional data. For example, when there is the change in data value between the second additional multi-dimensional data at the time t4 and the temporary reference time multi-dimensional data at the time t3 is within the predetermined threshold, the computing device 100 may obtain the second additional multi-dimensional data at the time t4 as the second reference time multi-dimensional data. Through this, the computing device 100 may more accurately identify the time when the change of the volume of the object is terminated, and a specific description of the process of obtaining the second reference time multi-dimensional data related thereto is described below through FIG. 7 below.

According to an exemplary embodiment of the present disclosure, the computing device 100 may predict the volume of the object based on the first reference time multi-dimensional data obtained through step S120 and the second reference time multi-dimensional data obtained through step S140 (S150). In this case, the computing device 100 may obtain a data value at the time when the change of the volume of the object is started based on the first reference time multi-dimensional data at the first reference time which is the time when the change of the volume of the object is started and obtain a data value at the time when the change of the volume of the object is terminated based on the second reference time multi-dimensional data at the second reference time which is the time when the change of the volume of the object is terminated. Thereafter, the computing device 100 may predict the change of the volume of the object through a difference in data value between the second reference time multi-dimensional data and the first reference time multi-dimensional data. In this case, the container may include a trapezoidal cylindrical container with a specified specification, and the computing device 100 may obtain information on a height, a width, diameters and areas of a bottom side and a top side, a curvature of a side, etc., so the computing device 100 may calculate a volume of the object contained in the container by using the obtained information. For example, when the first and second reference time multi-dimensional data is depth map data, the computing device 100 may calculate a height difference by comparing “a depth data value of an object area included in the first reference time multi-dimensional data” and “a depth data value of an object area included in the second reference time multi-dimensional data”. Further, the computing device 100 may obtain information on diameters and areas of a bottom side and a top side of a trapezoidal cylinder through a difference between “an area of the object area included in the first reference time multi-dimensional data” and “an area of the object area included in the second reference time multi-dimensional data”. Thereafter, the computing device 100 may predict the volume of the object based on the obtained height difference, and information on the diameters and the areas of the bottom side and the top side of the trapezoidal cylinder. Accordingly, the computing device 100 may more accurately identify the second reference time which is the time when volume change is terminated and the first reference time which is the time when the volume change is started through an exemplary embodiment of the present disclosures, and predicts the volume change of the object through the difference in data value between the first and second reference time multi-dimensional data to more accurately predict the volume of the object changed in real time.

FIG. 4 is a schematic view for describing a process of obtaining a plurality of multi-dimensional data including a container capable of containing an object based on time-series information according to an exemplary embodiment of the present disclosure.

Referring to FIG. 4, the computing device 100 may obtain a plurality of multi-dimensional data including a container capable of containing an object based on time-series information. In this case, the time-series information may mean information that may distinguish the plurality of multi-dimensional data using a time difference, and for example, the plurality of multi-dimensional data may be divided into T1-time multi-dimensional data and T2-time multi-dimensional data. For example, the computing device 100 may obtain a plurality of depth data containing the container using a depth camera, and the multi-dimensional data may include RGBD data. In this case, the depth camera may mean a camera that measures distance information to a specific point of an environment or an object, and the depth camera may include, for example, a camera which measures a depth value of each pixel in a 2D image to secure 3D information of a space. On the other hand, the plurality of multi-dimensional data may be obtained through technologies such as laser scanning, structural light scanning, a time-of-flight camera, a stereo vision system, photogrammetry, etc., in addition to a scheme of using the depth camera, and are not limited to an example such as the depth camera, etc.

Additionally, according to an exemplary embodiment of the present disclosure, the computing device 100 identifies an area including the container for at least one 10 of the plurality of obtained multi-dimensional data, and filters (11) the multi-dimensional data 10 based on the identified area to obtain filtered multi-dimensional data 12. For example, as an additional example, the computing device 100 may filter (11) the multi-dimensional data 10 based on depth data of an area including the container (basket). Specifically, the computing device 100 may perform filtering for the multi-dimensional data by filtering an area having a depth value smaller than the depth data of the area including the container (basket) based on the depth data of the area including the container (basket), but even in addition to the above example, various examples may be used. In this case, during the filtering process, pixels may be removed, and an example of applying an erode operation (morphology operation) may be used, but is not limited thereto. Meanwhile, the computing device 100 according to another exemplary embodiment of the present disclosure may filter the multi-dimensional data, and a description thereof is described below through FIGS. 5A and 5B below.

FIGS. 5A and 5B are schematic views for describing a process of identifying an area including the container for at least one of the plurality of obtained multi-dimensional data, and filtering the multi-dimensional data based on the identified area according to an exemplary embodiment of the present disclosure.

Referring to FIG. 5A, the computing device 100 may extract an external contour 15-1 of an object for at least one 12 of the plurality of obtained multi-dimensional data. Specifically, the computing device 100 may identify (13) contours of a container and an object included in at least one 12 of the plurality of obtained multi-dimensional data. For example, when the multi-dimensional data 12 is depth data, the computing device 100 may identify an area where a depth data value is rapidly changed as the contours of the container and the object, but besides, various examples may be used. Specifically, the computing device 100 may obtain an approximate area 15-1 of the object based on an external contour 14 of the object among the identified contours 13 of the container and the object. At this time, the computing device 100 identifies a parent contour completely surrounding the other contour among the identified contours 13 of the container and the object, and extracts a contour having a largest area among child contours completely surrounded by the parent contour to extract the external contour 14 of the object. Further, the computing device 100 calculates a circle which is in outer contact with the external contour 14 of an object having a non-uniform shape to obtain the approximation area 15-1 of the object. However, since the obtained approximation area 15-1 of the object does not include the area of the container capable of the object, a process of identifying a contour and an area of the container is required in order for the computing device 100 to calculate an accurate volume. However, unlike a minimum outer contact circle calculation method which may be used in the process of identifying the approximation area 15-1 of the object, a calculation method of obtaining a maximum inner contact circle requires a significant operation in order to identify the contour of the container and the area of the container. Accordingly, in order for the computing device 100 to accurately predict the volume of the object which changes in real time, another method for reducing a computation amount is required in addition to the calculation method of obtaining the maximum inner contact circle to identify the contour of the container and the area of the container.

In this regard, referring to FIG. 5B, the computing device 100 may extract an internal contour of a container for the multi-dimensional data 12, and identify an area including the container based on the external contour 15-1 of the object and the extracted internal contour of the container. Specifically, the computing device 100 may extract an approximation area 17 of the container based on a distance 16 between the approximation area 15-1 of the object and the internal contour of the container, and identify the approximation area 17 of the container as the area including the container. For example, the computing device 100 measures a distance between a center 15-2 of the approximation area 15-1 of the object and the internal contour of the container to calculate a closest distance 16. Thereafter, the computing device 100 may identify, as the approximation area 17, an approximation inner contact circle having a shortest distance 16 between the center 15-2 of the approximation area 15-1 of the object and the internal contour as a radius, and identify the identified approximation inner contact circle as the area including the container. Through this, the computing device 100 may identify the contour of the container and the area of the container rapidly by reducing the computation amount as compared with the calculation method of obtaining the maximum inner contact circle in order to identify the contour of the container and the area of the container. Meanwhile, the computing device 100 may obtain first reference time multi-dimensional data based on whether there is a change between the plurality of obtained multi-dimensional data, and a specific description related thereto is described below through FIGS. 6A and 6B below.

FIGS. 6A and 6B are schematic views for describing a process of obtaining first reference time multi-dimensional data based on whether the plurality of multi-dimensional data are changed according to an exemplary embodiment of the present disclosure.

According to an exemplary embodiment of the present disclosure, the computing device 100 may obtain first reference time multi-dimensional data 22′ based on whether there are the changes between the plurality of multi-dimensional data 21 or 22 obtained as above. Specifically, the computing device 100 may identify a first area 17-1 including first multi-dimensional data 21 among the plurality of multi-dimensional data 21 or 22, identify whether a data value of the first area 17-1 is changed in second multi-dimensional data 22 at a time after the first multi-dimensional data 21 among the plurality of multi-dimensional data 21 or 22, and obtain the first reference time multi-dimensional data 22′ based on whether the data value of the first area 17-1 is changed, which is identified. At this time, the first area 17-1 may mean a specific area included in the first or second multi-dimensional data 21 or 22, and for example, when the first or second multi-dimensional data 21 or 22 is an RGBD image, the first area 17-1 may mean an area of the container in an entire image, but is not limited thereto. Further, when the identified change of the data value of the first area 17-1 is within a predetermined threshold, the computing device 100 may obtain the second multi-dimensional data 22 as the first reference time multi-dimensional data 22′. In this regard, in order for the computing device 100 to predict the volume of the object which changes in real time, a process of accurately setting a first reference time at which the change of the volume is started and a second reference time at which the change of the volume is terminated is required. In this case, the first reference time may mean a time when the change of the object which becomes a target of the volume prediction is not started, and there should be no change in the data value included in the multi-dimensional data (one of 21 or 22) at the first reference time. For example, when food waste is loaded in the container sequentially over time, the depth data of the container may continue to change while the food waste is being loaded, and a time when the depth data of the container is not changed may be a time when the loading of the food waste is terminated or a time when the loading of the food waste is not started. Accordingly, the computing device 100 may identify whether the data value of the first area 17-1 is changed in the second multi-dimensional data 22 at the time after the first multi-dimensional data 21 among the plurality of multi-dimensional data 21 or 22, and when the identified change of the data value of the first area 17-1 is within a predetermined threshold, the computing device 100 obtains the second multi-dimensional data 22 as the first reference time multi-dimensional data 22′ to specify the first reference time at which the change of the volume of the container capable of the object is started and obtain the first reference time multi-dimensional data 22′.

First, referring to FIG. 6A, according to an exemplary embodiment of the present disclosure, the computing device 100 may identify the area of the container included in the first multi-dimensional data 21 at the time T1 as the first area 17-1. Thereafter, the computing device 100 may identify the area of the area included in the second multi-dimensional data 22 at the time T2 as the second area 17-2, and identify whether the data value of the first area 17-1 included in the second multi-dimensional data 22 is changed. In this case, the data value of the first area 17-1 may mean depth data, but is not limited thereto, and examples including a chroma, a brightness, etc., of a pixel may be used. Specifically, when the change of the data value of the first area 17-1 included in the second multi-dimensional data 22 is within 0.2 which is a predetermined threshold, the computing device 100 may set the time T2 as a first reference time, and obtain the second multi-dimensional data 22 as the first reference time multi-dimensional data 22′. For example, when a container is moving in order to contain food waste, the change of the data value of the first area 17-1 included in the second multi-dimensional data 21 may exceed the predetermined threshold. In this case, the computing device 100 may identify that the container is continuously moving in the second multi-dimensional data 22 at the time T2, and a process of identifying whether the data value is changed may be repeated until the movement stops. Further, when the identified change of the data value of the first area 17-1 is within the predetermined threshold, the computing device 100 may obtain the second multi-dimensional data 22 as the first reference time multi-dimensional data 22′ to specify the first reference time when the change of the volume for the container is started.

According to another embodiment of the present disclosure, referring to FIG. 6B, the computing device 100 may identify a contour area of the container included in the first multi-dimensional data 21 at the time T1 as a first' area 17-1′. Thereafter, the computing device 100 may identify a contour area of the container included in the second multi-dimensional data 22 at the time T2 as a second area 18, and identify whether data values of the first' area 17-1′ included in the second multi-dimensional data 22 are changed. In this case, the data value of the first' area 17-1′ or the second area 18 may mean depth data, but is not limited thereto. Specifically, the computing device 100 may calculate a ratio at which “the data value of the second area 18 included in the second multi-dimensional data 22” exceeds “the data value of the first' area 17-1′” based on “the data value of the first' area 17-1′”. Thereafter, when the exceeding ratio is within 0.2 which is a predetermined threshold, the computing device 100 may set the time T2 as the first reference time, and obtain the second multi-dimensional data 22 as the first reference time multi-dimensional data 22′. However, as the predetermined threshold, various examples may be used in addition to a numerical value of 0.2. For example, when a location of the container is being adjusted in order to contain the food waste, an element to change a depth data value, such as a hand of a person may be added above the container.

In this case, the computing device 100 may identify a data value which exceeds the data value of the first' area 17-1′ at the time T1 when there is no load above the container among the data values of the second area 18 at the time T2. Accordingly, the computing device 100 may calculate the ratio at which “the data value of the second area 18 included in the second multi-dimensional data 22” exceeds “the data value of the first' area 17-1′” based on “the data value of the first' area 17-1′”, and the computing device 100 may set the time T2 as the first reference time when the exceeding ratio is within 0.2 which is the predetermined threshold. Thereafter, the computing device 100 obtains the second multi-dimensional data 22 as the first reference time multi-dimensional data 22′ to specify the first reference time when the change of the volume of the container capable of containing is started, and obtain multi-dimensional data for the first reference time. Meanwhile, the obtained first reference time multi-dimensional data 22′ may be utilized in a process of predicting a volume of the object to be described below, and a specific process thereof is described below through FIG. 7 below.

FIG. 7 is a schematic view for describing a process of identifying whether a plurality of additional multi-dimensional data change after the plurality of multi-dimensional data, and obtaining second reference time multi-dimensional data among the plurality of additional multi-dimensional data based on the identified whether the plurality of additional multi-dimensional data change according to an exemplary embodiment of the present disclosure.

Referring to FIG. 7, the computing device 100 may identify whether a plurality of additional multi-dimensional data 23 or 24 after the plurality of obtained multi-dimensional data 21 or 22 are changed. For example, the computing device 100 may identify a change in data value between first additional multi-dimensional data 23 among the plurality of additional multi-dimensional data 23 or 24, and the first reference time multi-dimensional data 22′. In this case, the plurality of additional multi-dimensional data 23 or 24 may mean data distinguished from the plurality of obtained multi-dimensional data 21 or 22, and may include multi-dimensional data 23 or 24 at a time after the plurality of multi-dimensional data 21 or 22. For example, when the plurality of multi-dimensional data 21 or 22 are multi-dimensional data from the time T1 to the time T2, the plurality of additional multi-dimensional data 23 or 24 may include multi-dimensional data after a time T3. Further, when a change in data value between the first additional multi-dimensional data 23 and the first reference time multi-dimensional data 22′ is equal to or larger than a predetermined threshold, the computing device 100 compares the first additional multi-dimensional data 23 and the first reference time multi-dimensional data 22′ to determine that the change of the data value occurs. Specifically, the computing device 100 compares “a depth data value of a second' area 17-2′ included in the first reference time multi-dimensional data 22′” and “a depth data value of a third area 17-3 included in the first additional multi-dimensional data 23”, and when a change in data value between two depth data values is equal to or larger than 0.2 which is equal to or larger than a predetermined threshold, the computing device 100 compares the first additional multi-dimensional data 23 and the first reference time multi-dimensional data 22′ to determine that the change of the data value occurs. For example, when the container for containing the food waste is fixed to a predetermined location and loading of the food waste is started at the time T2, a height of the food waste at the time T3 may be larger than a height at the time T2. Accordingly, when the computing device 100 determines that the change of the data value occurs by comparing the first additional multi-dimensional data 23 and the first reference time multi-dimensional data 22′, the computing device 100 may determine that the volume of the object changes in real time. Thereafter, the computing device 100 may use the first additional multi-dimensional data 23 in a process of obtaining second reference time multi-dimensional data 24′.

In this regard, the computing device 100 may obtain the second reference time multi-dimensional data 24′ among the plurality of additional multi-dimensional data 23 or 24 based on identified change. Specifically, when the computing device 100 determines that the change of the data value occurs by comparing the first additional multi-dimensional data 23 and the first reference time multi-dimensional data 22′, the computing device 100 may obtain the first additional multi-dimensional data 23 as temporary reference time multi-dimensional data. In this case, the temporary reference time multi-dimensional data may mean data used in a process of obtaining the second reference time multi-dimensional data 24′. For example, the computing device 100 may obtain t2-time multi-dimensional data as the first reference time multi-dimensional data 22′, and when determining that there is a change in data value by comparing the t3-time multi-dimensional data 23 with the t2-time multi-dimensional data 22, the computing device 100 may obtain the t3-time first additional multi-dimensional data 23 as the temporary reference time multi-dimensional data. Thereafter, the computing device 100 may identify whether there is the change in data value between the second additional multi-dimensional data 24 and the temporary reference time multi-dimensional data 23. For example, the computing device 100 may identify whether there is a change in data value between the second additional multi-dimensional data 24 at the time T4 and the temporary reference time multi-dimensional data 24 at the time T3. In this case, when the change in data value between the second additional multi-dimensional data 24 at the time t4 and the temporary reference time multi-dimensional data 23 at the time t3 is larger than 0.2 which is a predetermined threshold, the computing device 100 may set the second additional multi-dimensional data 24 at the time t4 as the temporary reference time multi-dimensional data again. Through this, when the volume of the object which becomes the prediction target changes in real time, the computing device 100 may obtain additional multi-dimensional data 24 obtained at a relatively recent time as the temporary reference time multi-dimensional data, and may use the obtained temporary reference time multi-dimensional data in a process of obtaining second reference time multi-dimensional data 24′ to be described below to more accurately identify the time when the change of the volume of the object is terminated.

For example, when a change in data value between the second additional multi-dimensional data 24 at the time t4 and the first additional multi-dimensional data 23 which is the temporary reference time multi-dimensional data is within 0.2 which is a predetermined threshold, the computing device 100 may obtain the second additional multi-dimensional data 24 as the second reference time multi-dimensional data 24′. In this case, the embodiment described above in the present disclosure may be used in the process of identifying the change of the data value, but the present disclosure is not limited thereto. Through this, the computing device 100 may more accurately identify the time when the volume change of the object is terminated in a situation in which the volume of the object changes in real time.

Further, the computing device 100 may predict the volume of the object based on the first reference time multi-dimensional data 22′ and the second reference time multi-dimensional data 24′. For example, the computing device 100 may obtain an RGBD data value at the time T2 when the volume change of the object is started based on the first reference time multi-dimensional data 22′ which is the first reference time which is the time when the volume change of the object is started, and obtain an RGBD data value at the time T4 when the volume change of the object is terminated based on the second reference time multi-dimensional data 24′ at the second reference time which is the time when the volume change of the object is terminated. Thereafter, the computing device 100 may predict the change of the volume of the object through the difference in data value between the second reference time multi-dimensional data 24′ and the first reference time multi-dimensional data 22′. In this regard, the container may include a trapezoidal cylindrical container with a specified specification, and the computing device 100 may obtain information on a height, a width, diameters and areas of a bottom side and a top side, a curvature of a side, etc., so the computing device 100 may calculate a volume of the object contained in the container by using the obtained information. For example, when the first and second reference time multi-dimensional data 22′ and 24′ are RGBD data, the computing device 100 may calculate a depth difference by comparing “a depth data value of an object area included in the first reference time multi-dimensional data 22” and “a depth data value of an object area included in the second reference time multi-dimensional data 24′”. Further, the computing device 100 may obtain information on diameters and areas of a bottom side and a top side of a trapezoidal cylinder through a difference between “an area of an object area 17-2′ included in the first reference time multi-dimensional data 22′” and “an area of an object area 17-4 included in the second reference time multi-dimensional data 24′”. Thereafter, the computing device 100 may predict the volume of the object based on the obtained height difference, and information on the diameters and the areas of the bottom side and the top side of the trapezoidal cylinder. Accordingly, the computing device 100 may more accurately identify the second reference time which is the time when volume change is terminated and the first reference time which is the time when the volume change is started through an exemplary embodiment of the present disclosures, and predicts the volume change of the object through the difference in data value between the first and second reference time multi-dimensional data 22′ and 24′ to more accurately predict the volume of the object changed in real time.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

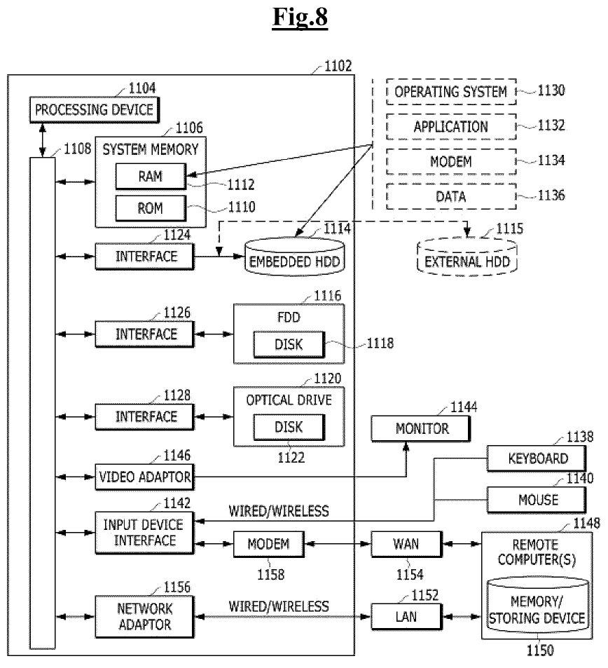

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal obtained by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for predicting a volume of an object, the method performed by one or more processors of a computing device, the method comprising:
obtaining a plurality of multi-dimensional data including a container capable of containing an object based on time-series information;
obtaining first reference time multi-dimensional data based on whether the plurality of multi-dimensional data are changed;
identifying whether a plurality of additional multi-dimensional data after the plurality of multi-dimensional data are changed;
obtaining second reference time multi-dimensional data among the plurality of additional multi-dimensional data based on identified change; and
predicting the volume of the object based on the first reference time multi- dimensional data and the second reference time multi-dimensional data.

2. The method of claim 1, wherein the plurality of multi-dimensional data including the container capable of containing the object is obtained based on a process of obtaining a plurality of depth data including the container capable of containing the object by using a depth camera.

3. The method of claim 1, wherein the multi-dimensional data includes RGBD data.

4. The method of claim 1, wherein the obtaining of the plurality of multi-dimensional data including the container capable of containing the object based on the time-series information further includes:
identifying an area including the container for at least one of the plurality of obtained multi-dimensional data; and
filtering the multi-dimensional data based on the identified area.

5. The method of claim 4, wherein the filtering of the multi-dimensional data based on the identified area includes:
filtering the multi-dimensional data based on depth data of the identified area.

6. The method of claim 4, wherein the identifying of the area including the container for at least one of the plurality of obtained multi-dimensional data includes:
extracting an external contour of an object for at least one of the plurality of obtained multi-dimensional data;
extracting an internal contour of the container for at least one of the plurality of obtained multi-dimensional data; and
identifying an area including the container for at least one of the plurality of obtained multi-dimensional data based on the external contour of the object and the extracted internal contour of the container.

7. The method of claim 6, wherein the extracting of the external contour of the object for at least one of the plurality of obtained multi-dimensional data includes:
obtaining an approximation area of the object based on the external contour of the object, and
wherein the identifying of the area including the container for at least one of the plurality of obtained multi-dimensional data based on the external contour of the object and the extracted internal contour of the container includes:
extracting an approximation area of the container based on a distance between the approximation area of the object and the internal contour of the container; and
identifying the area including the container for at least one of the plurality of obtained multi-dimensional data based on the approximation area of the container.

8. The method of claim 1, wherein the obtaining of the first reference time multi-dimensional data based on whether there are the changes between the plurality of multi-dimensional data includes:
identifying a first area included in first multi-dimensional data among the plurality of multi-dimensional data;
identifying whether a data value of the first area is changed in second multi- dimensional data at a time after the first multi-dimensional data among the plurality of multi-dimensional data; and
obtaining first reference time multi-dimensional data based on whether the data value of the first area has changed.

9. The method of claim 8, wherein the obtaining of the first reference time multi-dimensional data based on whether the data value of the first area has changed includes:
obtaining the second multi-dimensional data as the first reference time multi-dimensional data when the identified change of the data value of the first area is within a predetermined threshold.

10. The method of claim 1, wherein the identifying whether the plurality of additional multi-dimensional data after the plurality of multi-dimensional data are changed includes:
identifying a change in data value between first additional multi-dimensional data among the plurality of additional multi-dimensional data, and the first reference time multi-dimensional data; and
when the identified change in data value between the first additional multi-dimensional data and the first reference time multi-dimensional data is equal to or larger than a predetermined threshold, comparing the first additional multi-dimensional data and the first reference time multi-dimensional data to determine that the change of the data value occurs.

11. The method of claim 10, wherein the obtaining of the second reference time multi-dimensional data among the plurality of additional multi-dimensional data based on identified change includes:
when it is determined that the change of the data value occurs by comparing the first additional multi-dimensional data and the first reference time multi-dimensional data, obtaining the first additional multi-dimensional data as temporary reference time multi-dimensional data;
identifying whether there is a change in data value between second additional multi-dimensional data and the temporary reference time multi-dimensional data; and
obtaining the second reference time multi-dimensional data based on whether there is the change in data value between the second additional multi-dimensional data and the temporary reference time multi-dimensional data.

12. The method of claim 11, wherein the obtaining of the second reference time multi-dimensional data based on whether there is the change in data value between the second additional multi-dimensional data and the temporary reference time multi-dimensional data includes
when the change in data value between the second additional multi-dimensional data and the temporary reference time multi-dimensional data is within a predetermined threshold, obtaining the second additional multi-dimensional data as the second reference time multi-dimensional data.

13. A computer program stored in a non-transitory computer-readable storage medium, wherein the computer program causes one or more processors to perform operations for predicting a volume of an object when the computer program is executed by the one or more processors, the operations comprising:
an operation of obtaining a plurality of multi-dimensional data including a container capable of containing an object based on time-series information;
an operation of obtaining first reference time multi-dimensional data based on whether the plurality of multi-dimensional data are changed;
an operation of identifying whether a plurality of additional multi-dimensional data after the plurality of multi-dimensional data are changed;
an operation of obtaining second reference time multi-dimensional data among the plurality of additional multi-dimensional data based on identified change; and
an operation of predicting the volume of the object based on the first reference time multi-dimensional data and the second reference time multi-dimensional data.

14. The computer program of claim 13, wherein the operation of obtaining the plurality of multi-dimensional data including the container capable of containing the object based on the time-series information further includes:
an operation of identifying an area including the container for at least one of the plurality of obtained multi-dimensional data, and
an operation of filtering the multi-dimensional data based on the identified area.

15. The computer program of claim 14, wherein the operation of filtering the multi-dimensional data based on the identified area includes:
an operation of filtering the multi-dimensional data based on depth data of the identified area.

16. The computer program of claim 14, wherein the operation of identifying the area including the container for at least one of the plurality of obtained multi-dimensional data includes:
an operation of extracting an external contour of an object for at least one of the plurality of obtained multi-dimensional data;
an operation of extracting an internal contour of the container for at least one of the plurality of obtained multi-dimensional data; and
an operation of identifying an area including the container for at least one of the plurality of obtained multi-dimensional data based on the external contour of the object and the extracted internal contour of the container.

17. The computer program of claim 13, wherein the operation of obtaining the first reference time multi-dimensional data based on whether there are the changes between the plurality of multi-dimensional data includes
an operation of identifying a first area included in first multi-dimensional data among the plurality of multi-dimensional data,
an operation of identifying whether a data value of the first area is changed in second multi-dimensional data at a time after the first multi-dimensional data among the plurality of multi-dimensional data, and
an operation of obtaining first reference time multi-dimensional data based on whether the data value of the first area has changed.

18. The computer program of claim 17, wherein the operation of obtaining the first reference time multi-dimensional data based on whether the data value of the first area has changed includes:
an operation of obtaining the second multi-dimensional data as the first reference time multi-dimensional data when the identified change of the data value of the first area is within a predetermined threshold.

19. The computer program of claim 13, wherein the operation of identifying whether the plurality of additional multi-dimensional data after the plurality of multi-dimensional data are changed includes:
an operation of identifying a change in data value between first additional multi-dimensional data among the plurality of additional multi-dimensional data, and the first reference time multi-dimensional data; and
when the identified change in data value between the first additional multi-dimensional data and the first reference time multi-dimensional data is equal to or larger than a predetermined threshold, an operation of comparing the first additional multi-dimensional data and the first reference time multi-dimensional data to determine that the change of the data value occurs.

20. A computing device comprising:
at least one processor; and
a memory,
wherein the at least one processor is configured to:
obtain a plurality of multi-dimensional data including a container capable of containing an object based on time-series information;
obtain first reference time multi-dimensional data based on whether the plurality of multi-dimensional data are changed;
identify whether a plurality of additional multi-dimensional data after the plurality of multi-dimensional data are changed;
obtain second reference time multi-dimensional data among the plurality of additional multi-dimensional data based on identified change; and
predict the volume of the object based on the first reference time multi-dimensional data and the second reference time multi-dimensional data.
